(19) United States
(12) Patent Application Publication
(10) Pub. No.: US 2008/0298800 A1
(43) Pub. Date: Dec. 4, 2008

(54) TRANSMISSION DEVICE AND ROUTE VERIFYING METHOD

(75) Inventor: Kanji NAITO, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/055,737

(22) Filed: Mar. 26, 2008

(30) Foreign Application Priority Data
May 31, 2007 (JP) JP2007-144371

(51) Int. Cl. H04B 10/08

(52) U.S. Cl. 398/16

(57) ABSTRACT

A transmission device transmitting a data frame to an opposite transmission device by use of one virtual transmission path built up by a plurality of communication channels comprises a route control unit determining each of routes of the communication channels building up the virtual transmission path between the transmission device and the opposite transmission device, a circuit setup unit performing a circuit setup of the self-device based on the routes determined by the route control unit, and a test signal transmitting unit transmitting test signals to the opposite transmission device via the communication channels based on the circuit setup.

This application claims the benefit of Japanese Patent Application No. 2007-144371, filed on May 31, 2007 in the Japanese Patent Office, the disclosure of which is herein incorporated in its entirety by reference.

### BACKGROUND OF THE INVENTION

1. Field of the Invention

The present invention relates to a transmission device that transmits a data frame via one virtual transmission path built up by a plurality of communication channels.

2. Description of the Related Art

There is an Ethernet (registered trademark)-over-SONET/SDH technology of transmitting Ethernet (registered trademark) data on a SONET (Synchronous Optical NETwork)/SDH (Synchronous Digital Hierarchy) network. According to this technology, the Ethernet (registered trademark) frame is transmitted via a virtual concatenation (VCAT) built up by virtually concatenating a plurality of SONET/SDH channels (STS-n/VC-n). The virtual concatenation enables flexible bandwidth control to be attained.

The virtual concatenation is notated by STS-n-Xv or VC-n-Xv, depending on the number of channels STS-n or VC-n building up the virtual concatenation. For example, in the SONET network, the virtual concatenation built up by two STS-3C is notated by STS-3C-2v. Further, in the SDH network, the virtual concatenation built up by two VC-3 is notated by VC-3-2v.

Note that the following discussion will exemplify the SONET in high-speed digital communication systems based on optical fibers, however, the same technology can be applied to the SDH. Further, in the following discussion, STS-n and VC-n defined as a connection unit of byte streams, which establish the connection between the transmission devices in the SONET and SDH, are generically referred to as communication channels.

FIG. 11 is a diagram showing a concept of the virtual concatenation. An example in FIG. 11 is that the virtual concatenation built up by the two STS-3C (STS-3C#1 and STS-3C#2) is generated on an optical network between SONET transmission devices 101 and 102. A layer-2 protocol frame (which will hereinafter be simply termed the L2 frame) of the Ethernet (registered trademark) etc. is transmitted via the virtual concatenation.

FIG. 12 is a diagram showing conversion between the L2 frame and the SONET frame. In the network where the virtual concatenation is generated, as illustrated in FIG. 12, the predetermined L2 frame is segmented, and segmented pieces of frame data are allocated to respective signals on the SONET network where the virtual concatenation is built up. In the SONET transmission devices 101 and 102 illustrated in FIG. 11, the transmitting side device transmits the Ethernet (registered trademark) frame in a way that segments the frame into an STS-3C#1 signal and an STS-3C#2 signal, while the receiving side device reassembles the Ethernet (registered trademark) frame from the received STS-3C#1 signal and STS-3C#2 signal.

Incidentally, there is proposed a network enabling an automatic route setup by applying a GMPLS (Generalized Multi-Protocol Label Switching) technology to transfer control in a SONET/SDH network. In the GMPLS-applied network, a transmission network (data plane) for transferring real data and a control network (control plane) for controlling the transfer of the real data, are separately managed. In the control plane, the automatic route setup is carried out by executing protocols such as OSPF-TE (Open Shortest Path First-Traffic Engineering) and RSVP-TE (resource ReServation Protocol-Traffic Engineering).

In the network where this type of control plane is configured and the virtual concatenation is generated, as illustrated in FIG. 13, there is a case in which the communication channels (STS-3C#1 and STS-3C#2) building up the virtual concatenation for transmitting the L2 frame undergo the route setup so as to be transferred via the different routes by the automatic route setup of the control plane. FIG. 13 is a diagram showing a concept of transmitting the L2 frame, which represents a relation between the route setup by the control plane and the virtual concatenation.

As described above, when the communication channels building up the virtual concatenation are set up so as to be transferred via the different routes, SONET/SDH signals from which to assemble one L2 frame arrive a SONET/SDH device on the receiving side with a predetermined time difference.

An Ethernet (registered trademark) interface unit of the SONET/SDH device is provided with receiving buffers having a predetermined capacity in order to obviate this time difference. FIG. 14 is a diagram showing a concept of how the L2 frame is reassembled from SONET frames. Electric signals STS-3c#1 and STS-3c#2, which are received from an optical network and converted, are sequentially stored in the receiving buffers. A frame reassembling unit reassembles the L2 frame in a way that acquires payloads of respective frames by allocating positions of the SONET frames in the respective receiving buffers with H4-byte information in path overheads.

Note that the following disclosed documents are given as documents of the arts related to the invention of the present application. The patent document 1 is “Japanese Patent Laid-Open Publication No. 2005-217904” and the patent document 2 is “Japanese Patent Laid-Open Publication No. 2006-174046”.

In the network where the of control plane described above is configured and the virtual concatenation is generated, however, if the arrival time difference between the respective signals transmitted via the routes becomes too large over the capacity of the receiving buffers, the desired L2 frame is not reassembled to result in a failure in the layer-2 communications.

### SUMMARY

According to one aspect of one embodiment, a transmission device transmitting a data frame to an opposite transmission device by use of one virtual transmission path built up by a plurality of communication channels, the transmission device comprising: a route control unit determining each of routes of the communication channels building up the virtual transmission path between the transmission device and the opposite transmission device; a circuit setup unit performing a circuit setup of the self-device based on the routes determined by the route control unit; and a test signal receiving unit receiving test signals transmitted from the opposite transmission device via the communication channels based on the circuit setup by the circuit setup unit; and a route verifying unit verifying the routes of the communication channels, which are determined by the route control unit, in accordance with an arrival time difference between the respective test signals via the communication channels.

### BRIEF DESCRIPTION OF THE DRAWINGS

FIG. 1 is a diagram showing an example of an architecture of a SONET network built up by transmission devices in an embodiment;

FIG. 2 is a diagram showing a concept of a route setup by a control plane;

FIG. 3 is a diagram illustrating how a dummy signal is transmitted and received when setting up a circuit;

FIG. 4 is a diagram showing conveyance of the signal after transmitting and receiving the dummy signal;

FIG. 5 is a block diagram showing an outline of a functional configuration of a transmission device in the embodiment;

FIG. 6 is a diagram showing an in-depth functional configuration of the transmission device serving as a test signal transmitting side in the embodiment;

FIG. 7 is a diagram showing an example of a structure of the test signal;

FIG. 8 is a diagram showing an in-depth functional configuration of the transmission device serving as a test signal receiving side in the embodiment;

FIG. 9 is a diagram showing an example of a structure of the test response signal;

FIG. 10 is a flowchart showing an operational example of the transmission device in the embodiment;

FIG. 11 is a diagram showing a concept of a virtual concatenation;

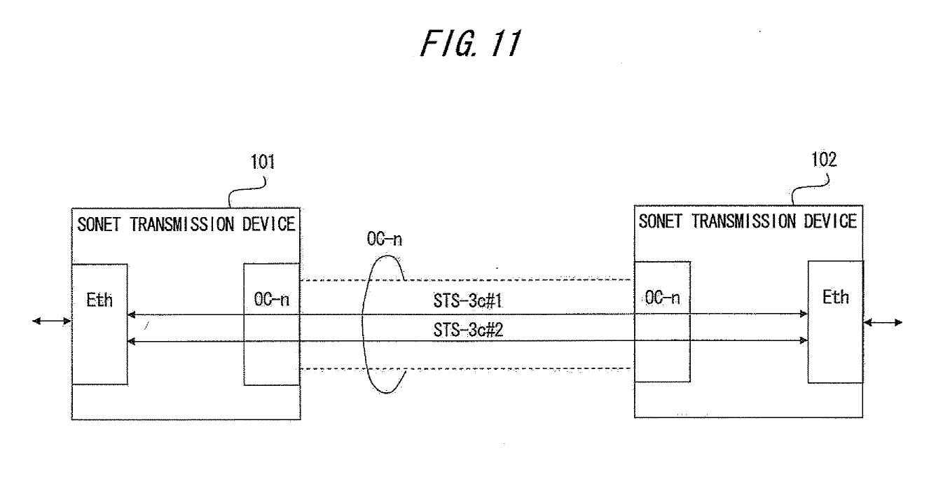

FIG. 12 is a diagram showing conversion between a L2 frame and a SONET frame;

FIG. 13 is a diagram showing a concept of how the L2 frame is transmitted, which represents a relation between the route setup by the control plane and the virtual concatenation; and

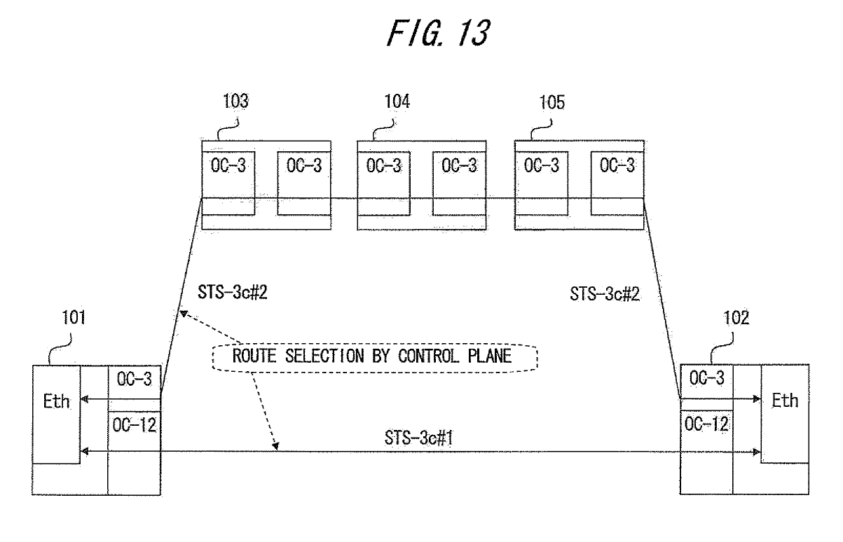

FIG. 14 is a diagram showing a concept of how the L2 frame is reassembled from the SONET frame.

### DESCRIPTION OF THE PREFERRED EMBODIMENTS

Each of transmission devices in an embodiment of the present invention will hereinafter be described with reference to the drawings. Plural pieces of transmission devices in the embodiment of the present invention are connected to each other via optical fibers etc, thus building up a SONET network. Note that the present embodiment will exemplify the SONET network, however, the same technique can be applied to the SDH network as well. Further, a configuration in the embodiment, which will be hereinafter be discussed, is an exemplification, and the present invention is not limited to the configuration in the following embodiment.

[Network Architecture]

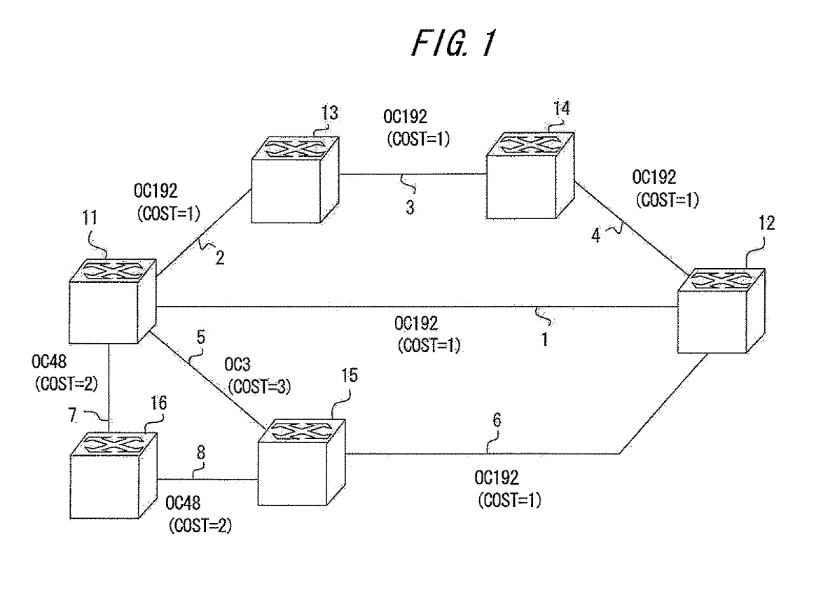

The SONET network in the embodiment, it is assumed, has an architecture as illustrated in FIG. 1. FIG. 1 is a diagram showing an example of the architecture of the SONET network built up by the transmission devices in the embodiment. Transmission devices 11 through 16 in the embodiment are, as illustrated in FIG. 1, connected to each other via optical fibers 1 through 8. To be specific, the transmission device 11 is connected via the optical fiber 1 to the transmission device 12, the transmission device 11 is connected via the optical fiber 2 to the transmission device 13, the transmission device 13 is connected via the optical fiber 3 to the transmission device 14, the transmission device 14 is connected via the optical fiber 4 to the transmission device 12, the transmission device 11 is connected via the optical fiber 5 to the transmission device 15, the transmission device 11 is connected via the optical fiber 7 to the transmission device 16, and the transmission device 15 is connected via the optical fiber 6 to the transmission device 12.

Optical signals, which are standardized as a digital hierarchy by the American National Standard Institute (ANSI), are transmitted through on these optical fibers. Specifically, the optical signals based on OC192 (Optical Carrier 192) having a transmission rate of 10 Gbps (Giga bit per second) are transmitted via the optical fibers 1, 2, 3, 4 and 6, the optical signals based on OC3 having a transmission rate of 155.52 Mbps (Mega bit per second) are transmitted via the optical fiber 5, and the optical signals based on OC48 having a transmission rate of 2.488 Gbps are transmitted via the optical fibers 7 and 8.

The network in the embodiment realizes the transmission of data based on the Layer 2 Protocol (which will hereinafter be abbreviated to L2) of Ethernet (registered trademark) etc on the thus-configured SONET network.

[Outline of Operation]

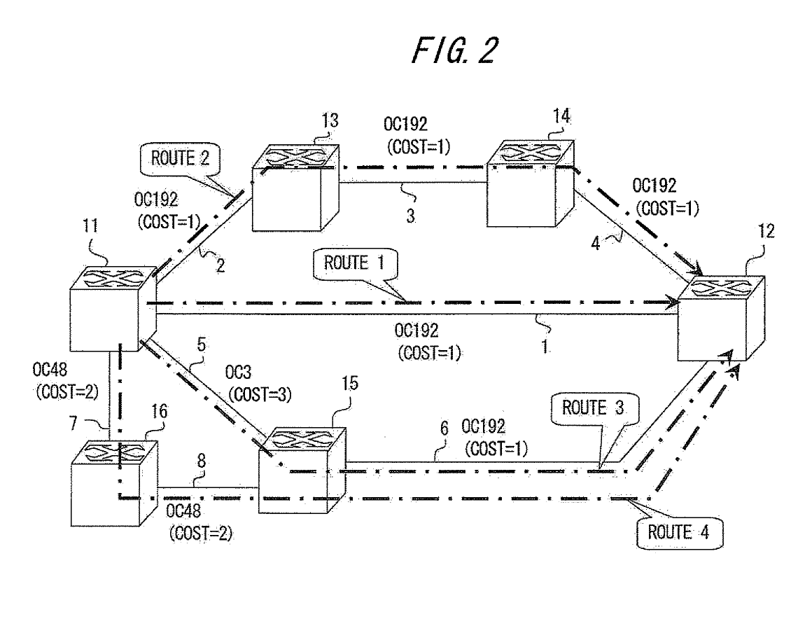

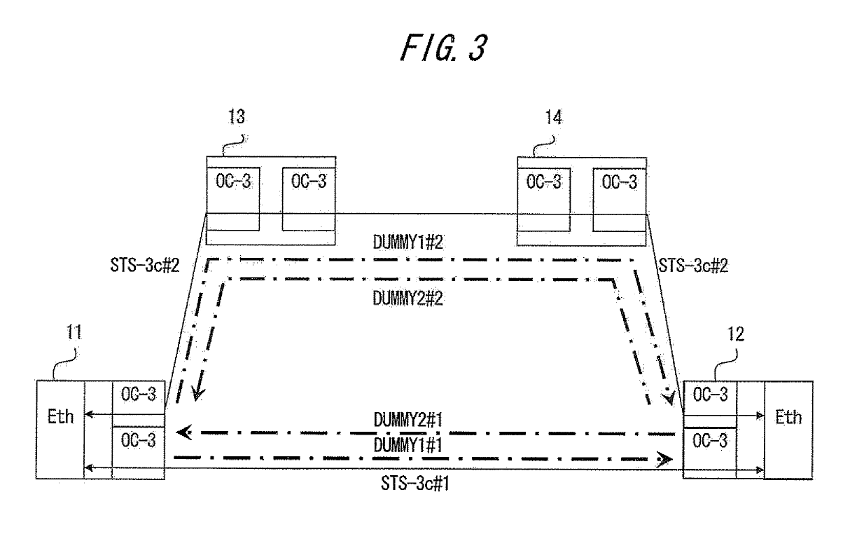

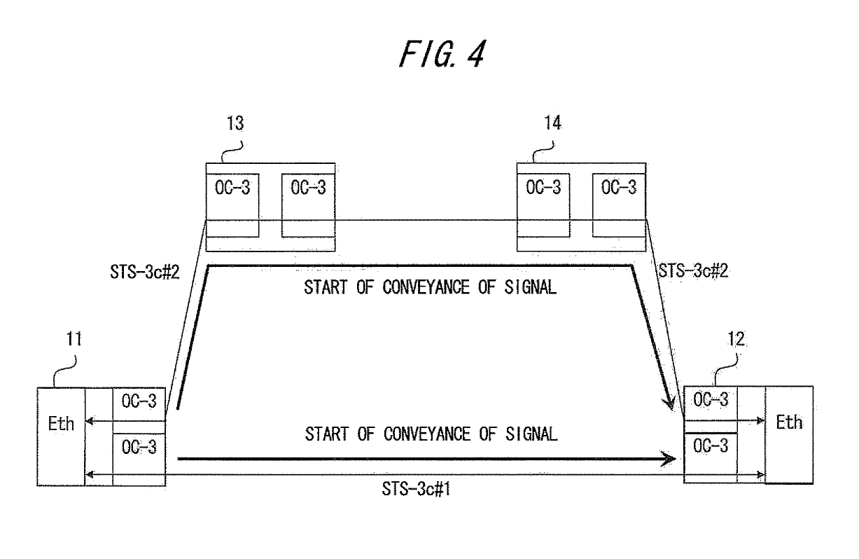

Herein, an outline of the operation of the transmission device in the embodiment will be explained with reference to FIGS. 2, 3 and 4. FIG. 2 is a diagram showing a concept of routing based on a control plane, FIG. 3 is a diagram illustrating how a dummy signal is transmitted and received when setting up a circuit, and FIG. 4 is a diagram showing how the signal is conveyed after transmitting and receiving the dummy signal.

To begin with, each of the transmission devices serving as edges among the transmission devices in the embodiment determines a route for each of communication channels configuring the virtual concatenation on the control plane. Herein, the “transmission devices serving as the edges” represent transmission target devices, e.g., a sender (source) transmission device and a recipient (destination) transmission device of an L2 frame.

The circuit setup to a cross-connect unit within each transmission device is individually conducted corresponding to a route of each communication channel that is determined on the control plane. An example in FIG. 2 shows how respective routes of STS-3C#1 and STS-3C#2 configuring the virtual concatenation between the edge transmission device 11 and the edge transmission device 12, are set as a route 1 and a route 2, respectively.

The edge transmission device in the embodiment, upon completing the circuit setup of each communication channel, executes a route verifying process about the virtual concatenation that will be shown below. In the route verifying process, the edge transmission device 11, at first, as illustrated in FIG. 3, transmits a test signal by use of each of the communication channels configuring the virtual concatenation, and verifies whether or not each test response signal is received as a response to the test signal within a predetermined period of monitoring time. To be specific, the edge transmission device 11 generates a SONET/SDH frame (test frame) containing a dummy payload, and further generates test signals (DUMMY1#1 and DUMMY1#2) to which the test frame is segmented and the segmented test frames are allocated. The edge transmission device 11 transmits each test signal from an optical interface that has undergone the circuit setup by the control plane.

On the other hand, the edge transmission device 12, when receiving each of the test signals from each of the routes, verifies the received test signal. The edge transmission device 12, if the verification gets successful, generates test response signals (DUMMY2#1 and DUMMY2#2). The edge transmission device 12 transmits each test response signal from the optical interface that has undergone the circuit setup by the control plane.

The edge transmission device 11 judges whether or not each of the test response signals (DUMMY2#1 and DUMMY2#2) is properly received as the response to the test signal within a predetermined period of monitoring time. If verified as a proper route from this judgment, the route setup at that point of time is retained, and, as shown in FIG. 4, the data transmission based on the virtual concatenation is started between the edge transmission device 11 and the edge transmission device 12. Whereas if verified as an improper route, for example, the control plane is controlled so that another route is selected.

[Functional Configuration]

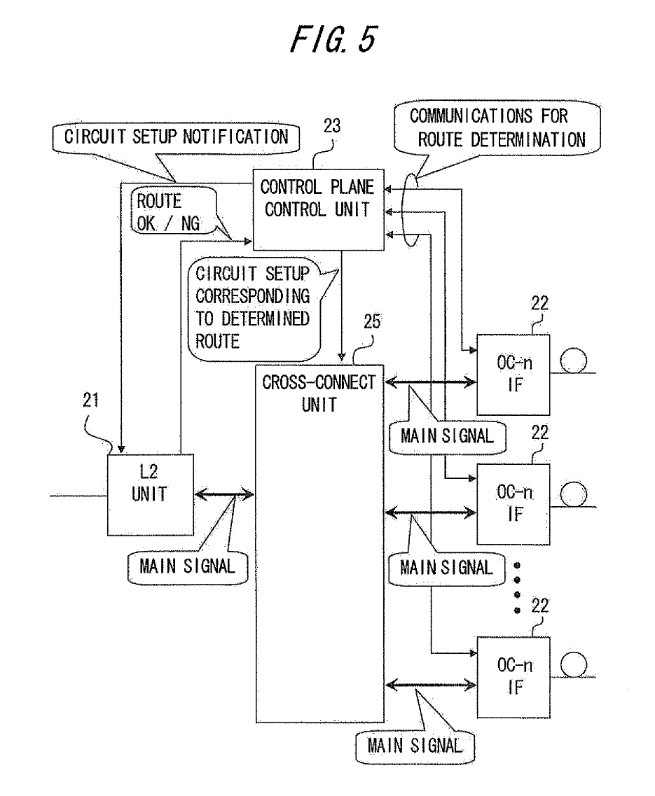

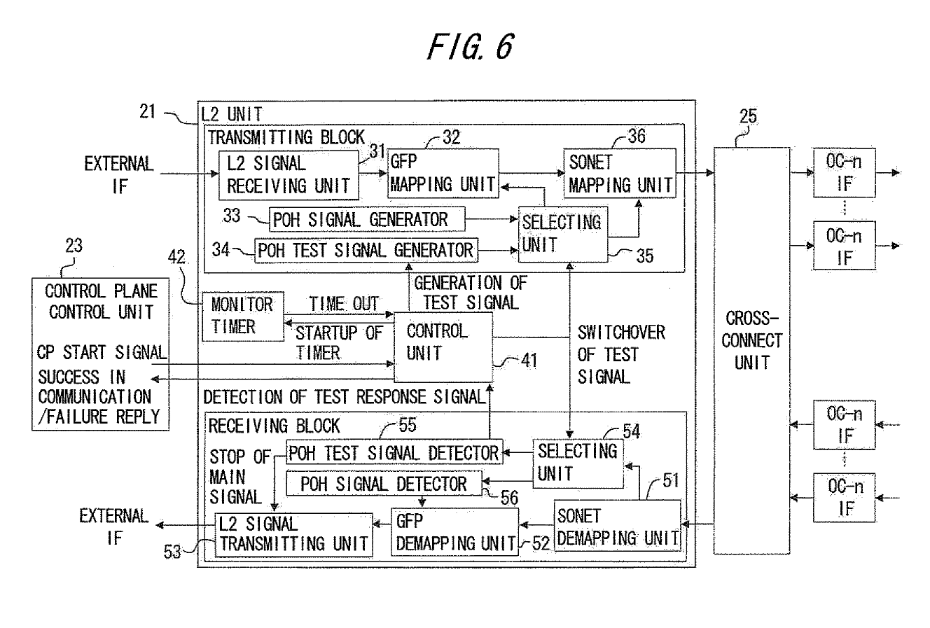

Next, functional configurations of the transmission devices 11 and 12 serving as the edges among the transmission devices 11 through 16 in the embodiment will be described with reference to FIGS. 5 and 6. FIG. 5 is a block diagram showing an outline of the functional configuration of the transmission device in the embodiment. In the following discussion, unless any distinction is required, in the case of explaining contents of the functions common to the transmission devices throughout, the descriptions thereof shall be made without putting the reference symbols and numerals.

The transmission device in the embodiment includes a L2 unit 21, a plurality of optical interface units 22 (each designated by OC-n IF in FIG. 5), a control plane control unit 23, a cross-connect unit 25, etc. The transmission device in the embodiment is constructed of, as a hardware architecture, a CPU (Central Processing Unit), a memory, an input/output interface, etc. The function units such as the control plane control unit 23 may be configured so that these function units are realized by the CPU's executing the control program stored in the memory etc, and may also be configured so that at least one dedicated chip realizes each of the function units. It should be noted that the present invention does not limit the hardware architecture of the transmission device.

The optical interface unit 22 has an optical connector (unillustrated) serving as an external interface connected to the optical fiber etc. The optical interface unit 22 receives the optical signal (e.g., an OC192 signal) transmitted from an opposite device via the external interface, and sends the received optical signal to the cross-connect unit 25. Further, the optical interface unit 22 transmits the optical signal sent from the cross-connect unit 25 to the opposite device via the external interface. Note that the optical interface unit 22 may include an optical signal-electric signal converting unit (unillustrated), whereby the electric signal may be transmitted to and received from the cross-connect unit 25.

The control plane control unit 23 executes, e.g., a GMPLS process, thereby managing the control plane that controls the transfer in the SONET network. Specifically, the control plane control unit 23, on the occasion of establishing the connections between the L2 interfaces of the edge transmission devices, performs automatic circuit setup of each of the communication channels included in the virtual concatenation that accommodates the traffic between the L2 interfaces. The control plane control unit 23 acquires information on the transmission devices becoming the edges and information on a quantity of data etc flowing between the L2 interfaces of the respective edge transmission devices from, for example, user interfaces (unillustrated). The control plane control unit 23 conducts the circuit setup of each communication channel on the basis of the information acquired from the user interfaces in a way that transmits and receives routing information (such as a circuit cost (a weight on the circuit)) necessary for the routing of each communication channel to and from other transmission devices.

The control plane control unit 23 performs, with respect to the cross-connect unit 25, the circuit setup of the self-device in accordance with the determined routing information. The control plane control unit 23, upon completing the circuit setup in the cross-connect unit 25, notifies the L2 unit 21 of this purport. On the other hand, the control plane control unit 23 operates so that the circuit setup based on the determined routing information is done by each transmission device, and sends a predetermined control message to other transmission devices via the optical interface units 22. It is to be noted that the present invention does not restrict the routing technique executed by the control plane, and hence its description is simplified.

The control plane control unit 23 receives, after notifying of the completion of the circuit setup, notification showing whether the route verification gets successful or gets into a failure from the L2 unit 21. The control plane control unit 23, when receiving the notification showing the success in the route verification, retains the already-completed circuit setup. While on the other hand, the control plane control unit 23, when receiving the notification showing the failure in the route verification, cancels the already-completed circuit setup, and re-executes a new circuit setup other than the circuit with the failure in the route verification. The control plane control unit 23, when the new circuit setup is completed through the re-execution of the circuit setup, notifies of the L2 unit 21 of this purport. The control plane control unit 23, when continuously failing to re-execute the new circuit setup, may issue a circuit failure alarm or a circuit setup-disabled alarm.

The cross-connect unit 25, when receiving the signals to which the SONET/SDH frame is segmented and the segmented frames are allocated respectively from the L2 units 21, distributes the signals on a communication-channel-basis to the optical interface units 22, corresponding to the circuit setup done by the control plane control unit 23.

The L2 unit 21 has, as the external interface, e.g., an Ethernet (registered trademark) connector (not shown), and receives a L2 frame inputted from the Ethernet connector. The L2 unit 21 maps the L2 frame to the SONET/SDH frame in order to transmit the thus-received L2 frame through the predetermined virtual concatenation. The L2 unit 21 transmits the thus-generated signals building up the virtual concatenation to the cross-connect unit 25.

On the other hand, the L2 unit 21, upon receiving the signals building up the circuit setup from the cross-connect unit 25, assembles the L2 frame from these signals, and transmits the L2 frame via the external interface.

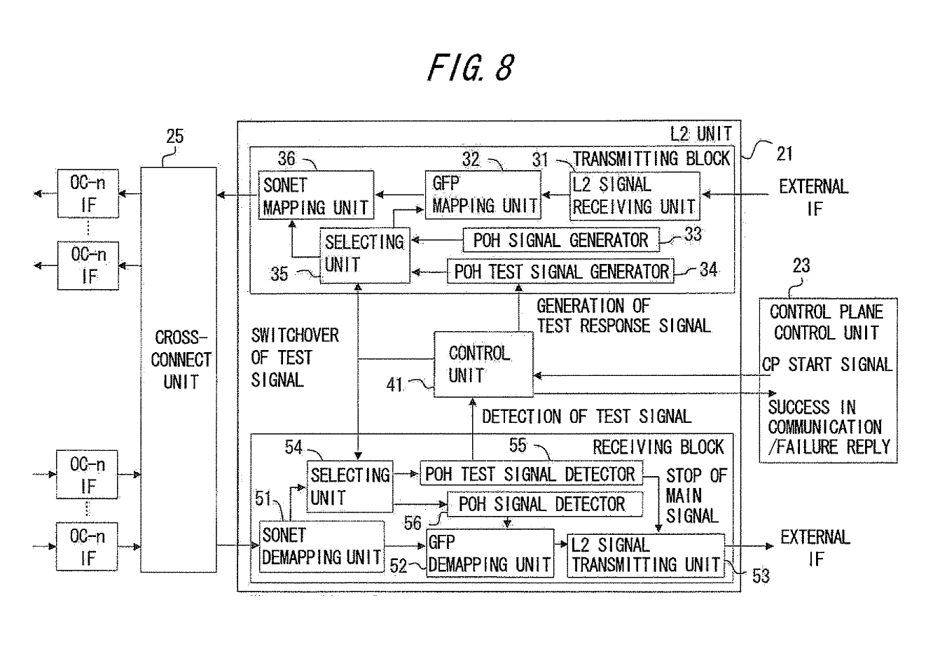

Moreover, the L2 unit 21, when receiving the notification of the completion of the circuit setup from the control plane control unit 23, executes the route verifying process described above. Detailed function units of the L2 unit 21, which are related to the route verifying process, will hereinafter be described with reference to FIGS. 6 and 8. Note that the following discussion will deal with the detailed function units of the L2 unit 21 in a way that separates the edge transmission devices according to the embodiment into the test signal transmitting side, i.e., the route verifying process starting side and into the test signal receiving side, however, these function units may all be provided in the single transmission device and may also be constructed as separate transmission devices.

<L2 Unit of Transmission device on Test Signal Transmitting Side>

To start with, each of the detailed function units of the L2 unit 21 in a case where the edge transmission device according to the embodiment becomes the test signal transmitting side, will be described with reference to FIG. 6. FIG. 6 is a diagram showing an in-depth functional configuration of the transmission device serving as the test signal transmitting side in the embodiment.

The L2 unit 21 includes, as transmitting blocks, a L2 signal receiving unit 31, a GFP (Generic Framing Procedure) mapping unit 32, a POH (Path OverHead) signal generator 33, a POH test signal generator 34, a selecting unit 35, a SONET mapping unit 36, further includes, as receiving blocks, a SONET demapping unit 51, a GFP demapping unit 52, a L2 signal transmitting unit 53, a selecting unit 54, a POH test signal detector 55, a POH signal detector 56, and still further includes, as function units for controlling the whole, a control unit 41 and a monitoring timer 42.

<<Transmitting Blocks>>

The L2 signal receiving unit 31 receives the L2 signals from the external interface and converts the received L2 signals into the L2 frame. The converted L2 frame is sent to the GFP mapping unit 32.

The GFP mapping unit 32 maps an asynchronous L2 frame to a synchronous frame. The L2 frame mapped to the synchronous frame is sent to the SONET mapping unit 36.

The POH signal generator 33 generates a normal POH signal. The generated POH signal is transmitted to the selecting unit 35.

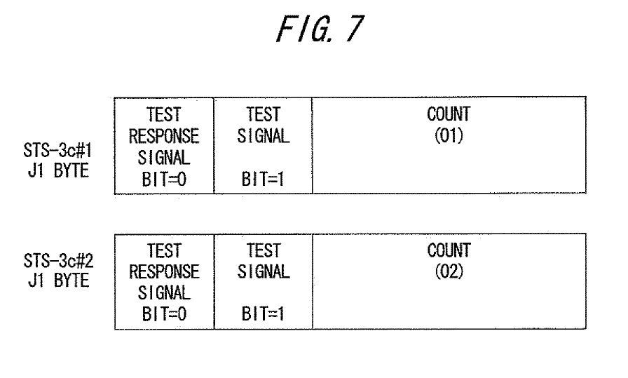

The POH test signal generator 34 generates each test signal transmitted via each of the communication channels building up the virtual concatenation on the basis of an instruction given from the control unit 41. The test signals are equivalent to the signals to which the L2 frame (test L2 frame) having a dummy payload is segmented and the segmented frames are allocated, and are distinguished from other normal signals, for example, by containing test signal identifying data in J1 bytes of the POH. Accordingly, the POH test signal generator 34 generates the POH signal having the J1 bytes shown in FIG. 7 as the test signal and transmits the test signal to the selecting unit 35.

FIG. 7 is a diagram illustrating an example of a structure of the test signal. The example in FIG. 7 is that the test signal has the POH J1 bytes containing a bit specifying the test signal, a bit specifying the test response signal and a count field. Owing to this structure, the transmission device receiving the test signal can judge whether the received signal is the test signal or not by referring to the POH J1 bytes. In the test signal, the test signal bit of the J1 bytes is set to “1”, while the test response signal bit thereof is set to “0”. Data for specifying the identical test L2 frame is set in the count field. A sequence number or the same number of each test signal may be set in the count field.

The selecting unit 35 transmits, to the SONET mapping unit 36, any one of the POH signal generated by the POH signal generator 33 and the test signal generated by the POH test signal generator 34. The selecting unit 35 selects a should-be-output signal on the basis of the instruction given from the control unit 41. The selecting unit 35 notifies, based on the instruction given from the control unit 41, the GFP mapping unit 32 that the output to the SONET mapping unit 36 be stopped.

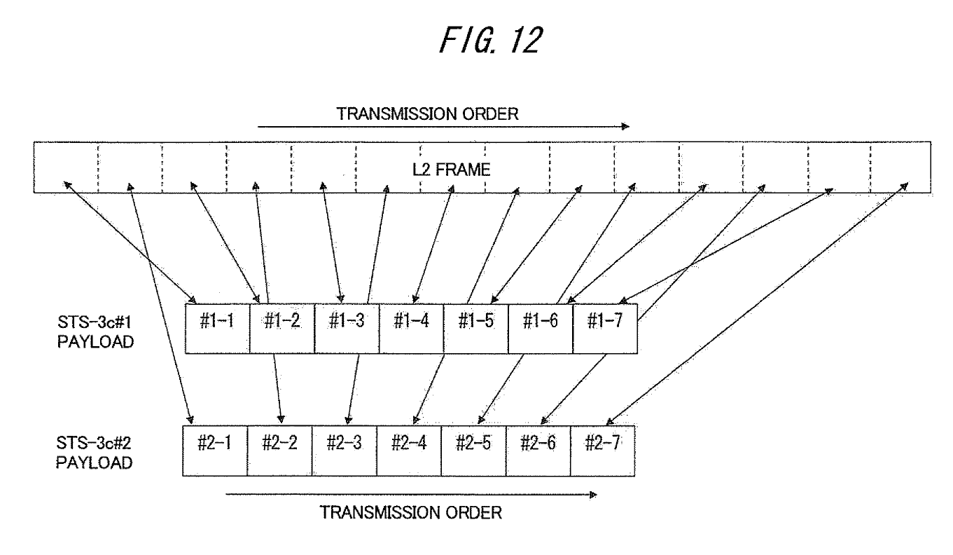

The SONET mapping unit 36, when receiving the POH signal generated by the POH signal generator 33 from the selecting unit 35, as illustrated in FIG. 12, maps the L2 frame sent from the GFP mapping unit 32 to each of the signals of the virtual concatenation. Further, the SONET mapping unit 36 maps the POH signal transmitted from the selecting unit 35 to the POH of each of the signals of the virtual concatenation.

The SONET mapping unit 36, upon receiving each of the test signals generated by the POH test signal generator 34 from the selecting unit 35, maps each test signal to the POH of each of the signals configuring the virtual concatenation. In this case, any inconvenience may not be caused by setting whatever data in the payload field of each signal generated by the SONET mapping unit 36. Each of the thus-generated signals is transmitted to the cross-connect unit 25.

<<Receiving Blocks>>

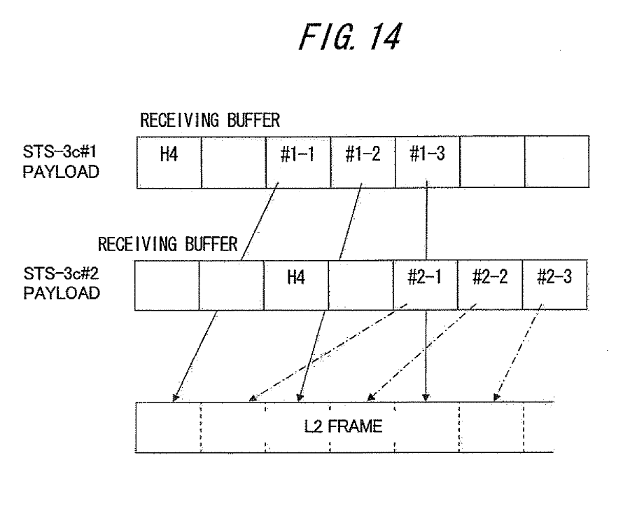

The SONET demapping unit 51 includes a plurality of receiving buffers (not shown in FIG. 6) as illustrated in FIG. 14. The receiving buffers are provided corresponding to, for example, the number of communication channels building up the virtual concatenation, and have a size (capacity) capable of storing in a normal state all the signals enabling one L2 frame to be reassembled. The SONET demapping unit 51 sequentially stores the signals transmitted from the cross-connect unit 25 in the receiving buffer, and detaches the POH and the payload from the signal stored in the receiving buffer. The SONET demapping unit 51 sends the detached payload to the GFP demapping unit 52 and sends the POH to the selecting unit 54.

The selecting unit 54 outputs, based on the instruction given from the control unit 41, the POH signal transmitted from the SONET demapping unit 51 to any one of the POH test signal detector 55 and the POH signal detector 56.

The POH signal detector 56 acquires the data set in the POH signal transmitted from the selecting unit 54. When the POH signal detector 56 acquires the POH signal, this POH signal is the normal POH signal, and hence the L2 frame is reassembled based on the data acquired from this POH signal.

The POH test signal detector 55, upon receiving each of the POH signals transmitted via the communication channels building up the virtual concatenation from the selecting unit 54, instructs the L2 signal transmitting unit 53 to stop transmitting the signal, and checks an arrival time difference between the respective test response signals via the communication channels on the basis of each POH signal. Namely, according to the example in FIG. 3, the POH test signal detector 55 checks the arrival time difference between the test response signal (DUMMY2#1) transmitted via the communication channel STS-3c#1 from the opposite transmission device and the test response signal (DUMMY2#2) transmitted via the communication channel STS-3c#2 therefrom. At this time, the POH test signal detector 55 refers to the POH J1 bytes of the test response signal, and thus judges the signal to be the test response signal. Note that the process of instructing the L2 signal transmitting unit 53 to stop the transmission intends to restrain the unnecessary data from being output because of none of the should-be-output user data being contained in the payload of the test response signal.

The POH test signal detector 55 determines whether or not the arrival time difference between the respective test response signals via the communication channels falls within a predetermined period of allowable time, and notifies the control unit 41 of a result of this determination. The POH test signal detector 55, if the arrival time difference falls within the predetermined allowable time, determines that the test response signal is normally received. If the arrival time difference between the respective test response signals via the communication channels falls within the predetermined allowable time, the L2 frame segmented based on the virtual concatenation can be reassembled, and hence this determination has the same implication as the route of each of the communication channels configuring the virtual concatenation is judged to be normal. Namely, the POH test signal detector 55 determines whether the arrival time difference between the signals transmitted via the routes (communication channels) becomes too large over the capacity of the receiving buffers to reassemble the L2 frame or not. The predetermined allowable time is determined corresponding to, for example, the size (capacity) of the receiving buffers and is retained adjustably in the memory etc beforehand.

The GFP demapping unit 52 reassembles the asynchronous L2 frame by aggregating the signals transmitted from the SONET demapping unit 51 on the virtual concatenation basis. The thus-reassembled L2 frame is transmitted to the L2 signal transmitting unit 53.

The L2 signal transmitting unit 53 converts the L2 frame sent from the GFP demapping unit 52 into the L2 signals, and transmits the converted L2 signals via the external interface.

<<Control Blocks>>

The monitoring timer 42 executes a monitor timer startup based on the instruction of the control unit 41, and when a predetermined period of monitor time elapses, notifies the control unit 41 of timeout. In the transmission device on the test signal receiving side, if the test signal is not received in a L2 frame reassembly-enabled status, or alternatively if the test signal is not normally received due to a communication failure etc on an onward route, the test response signal is not transmitted from the transmission device on the test signal receiving side. Further, in the transmission device on the test signal receiving side, though the test response signal has been transmitted, if the communication failure etc occurs on a return route, the transmission device on the test signal transmitting side does not normally receive the test response signal. The monitoring timer 42, which is a timer for detecting this type of phenomenon, monitors that the test response signal to the transmitted test signal is transmitted back from the transmission device on the test signal receiving side during the predetermined period of monitor time. The predetermined period of monitor time is previously retained adjustably in the memory etc.

The control unit 41, upon receiving the notification of the completion of the circuit setup from the control plane control unit 23, executes the route verifying process. The control unit 41 monitors a timeout in the route verifying process. To be specific, the control unit 41 instructs the monitoring timer 42 to conduct the timer startup when executing the route verifying process, and waits for timeout notification from the monitoring timer 42.

The control unit 41, simultaneously with the start of monitoring the timeout, instructs the selecting unit 35 to perform switchover so as to output the POH signal from the POH test signal generator 34, and further instructs the selecting unit 54 to perform the switchover so as to output the signal transmitted from the SONET demapping unit 51 to the POH test signal detector 55. Thereafter, the control unit 41 instructs the POH test signal generator 34 to generate the POH signal for the test signal.

On the other hand, the control unit 41 receives, from the POH test signal detector 55, the notification purporting that the test response signal has been normally received. The control unit 41, when receiving this notification before the monitoring timer 42 notifies of the timeout, sets the previously-switched selecting units 35 and 54 back in their original status. Namely, the control unit 41 instructs the selecting unit 35 to perform the switchover so as to output the POH signal from the POH signal generator 33, and further instructs the selecting unit 54 to conduct the switchover so as to output the signal transmitted from the SONET demapping unit 51 to the POH signal detector 56. Hereafter, the normal data transmission based on the virtual concatenation is started.

The control unit 41, irrespective of having the timeout notification from the monitoring timer 42, if the notification purporting that the test response signal has normally been received is not yet given from the POH test signal detector 55 at that point of time, judges this to be the failure in the route verification, and sends this result to the control plane control unit 23.

<L2 Unit of Transmission device on Test Signal Receiving Side>

Next, the detailed function units of the L2 unit 21 in a case where the edge transmission device according to the embodiment becomes the test signal receiving side, will be respectively described with reference to FIG. 8. FIG. 8 is a diagram showing an in-depth functional configuration of the transmission device becoming the test signal receiving side in the embodiment. The L2 unit of the transmission device serving as the test signal receiving side has, except that the monitoring timer 42 is not required, absolutely the same functional configuration as that of the transmission device becoming the test signal transmitting side illustrated in FIG. 7. Only the function units performing different operations from those of the L2 unit 21 of the transmission device on the test signal transmitting side described above, will hereinafter be described.

<<Receiving Blocks>>

The POH test signal detector 55, upon receiving each of the POH signals transmitted via the communication channels building up the virtual concatenation from the selecting unit 51, instructs the L2 signal transmitting unit 53 to stop transmitting the signal, and checks an arrival time difference between the respective test signals via the communication channels on the basis of each POH signal. Namely, according to the example in FIG. 3, the POH test signal detector 55 checks the arrival time difference between the test signal (DUMMY1#1) transmitted via the communication channel STS-3c#1 from the opposite transmission device and the test signal (DUMMY1#2) transmitted via the communication channel STS-3c#2 therefrom. At this time, the POH test signal detector 55 refers to the POH J1 bytes of the test signal, and thus judges the signal to be the test signal. The POH test signal detector 55 determines whether or not the arrival time difference between the respective test signals via the communication channels falls within a predetermined period of allowable time, and notifies the control unit 41 of a result of this determination. The way of how the reception of the test signal is determined is the same as the determination of the reception of the test response signal described above.

<<Control Blocks>>

The control plane control unit 23 notifies the control unit 41 of the notification of completion of the circuit setup. With this notification, the control unit 41 switches over the selecting unit 35 so as to output the POH signal transmitted from the POH test signal generator 34, and further switches over the selecting unit 54 so as to output the signal transmitted from the SONET demapping unit 51 to the POH test signal detector 55.

The control unit 41, upon receiving the notification purporting that the test signal has been normally received from the POH test signal detector 55, notifies the control plane control unit 23 of this purport, and simultaneously instructs the POH test signal generator 34 to generate the POH signal for the test response signal. On the other hand, the control unit 41, if the arrival time difference between the respective test signals via the communication channels does not fall within the predetermined period of allowable time or alternatively when receiving the notification purporting that the test signal is not received, sets the previously-switched selecting units 35 and 54 back in their original status. Namely, the control unit 41 switches over the selecting unit 35 so as to output the POH signal from the POH signal generator 33, and further switches over the selecting unit 54 so as to output the signal transmitted from the SONET demapping unit 51 to the POH signal detector 56. With this scheme, the transmission device on the test signal receiving side, if unable to receive the test signal in the L2 frame reassembly-enabled status or alternatively if unable to normally receive the test signal due to the communication failure etc on the onward route, does not transmit the test response signal. In the transmission device on the test signal transmitting side, this state is detected through monitoring the timeout by use of the monitoring timer 42.

<<Transmitting Blocks>>

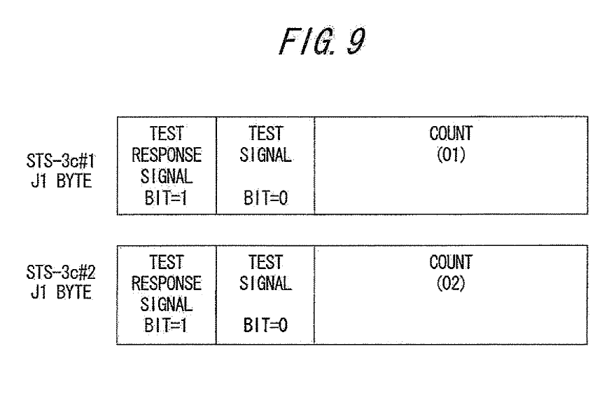

The POH test signal generator 34 generates each of the test response signals transmitted via the communication channels of the virtual concatenation on the basis of the instruction given from the control unit 41. Each test response signal contains data identifying whether the test signal is or not in, e.g., the POH J1 bytes and is thereby distinguished from other normal signals. The POH test signal generator 34 generates the POH signal as the test response signal having the J1 bytes as shown in FIG. 9, and transmits the POH signal to the selecting unit 35

FIG. 9 is a diagram showing an example of a structure of the test response signal. The example in FIG. 9 corresponds to the test signal in the example in FIG. 7, and, in the test response signal, the test signal bit of the J1 bytes is set to “0”, while the test response signal bit is set to “1”.

The selecting unit 35 transmits, to the SONET mapping unit 36, any one of the POH signal generated by the POH signal generator 33 and the test response signal generated by the POH test signal generator 34. The selecting unit 35 selects the should-be-output signal on the basis of the instruction given from the control unit 41. The selecting unit 35 notifies, based on the instruction given from the control unit 41, the GFP mapping unit 32 that the output to the SONET mapping unit 36 be stopped.

### Operational Example

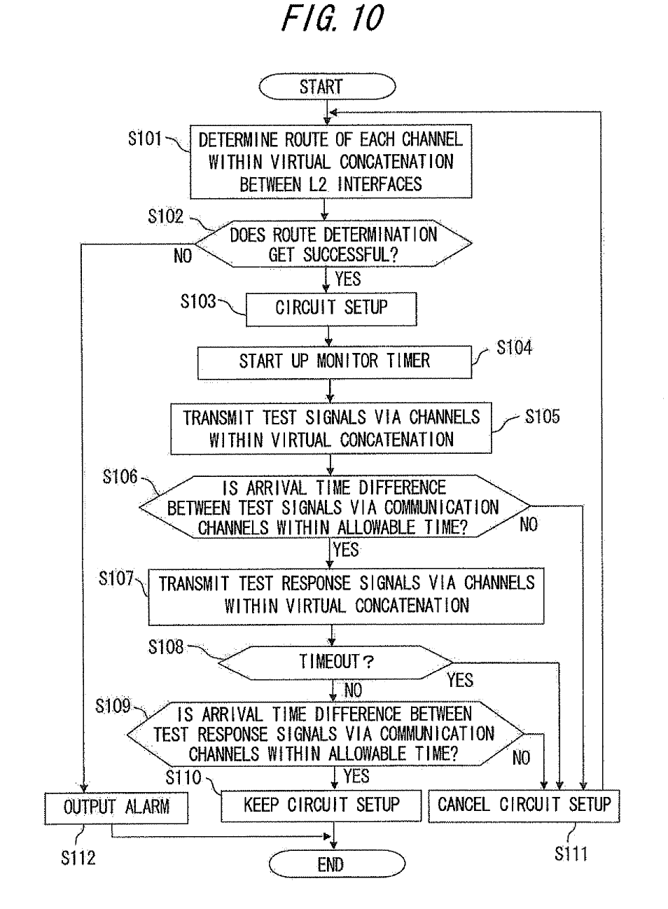

Operational examples of the edge transmission devices 11 and 12 among the transmission devices 11 through 16 in the embodiment, will hereinafter be described with reference to FIG. 10. FIG. 10 is a flowchart showing the operational example of the transmission device in the embodiment.

A virtual concatenation STS-3C-2v is built up between the L2 interfaces of the edge transmission devices 11 and 12, and, e.g., the edge transmission device 11 is notified, via the user interface, of information purporting such a demand that a predetermined quantity of data be transferred and received by use of the virtual concatenation STS-3C-2v. In the transmission device 11 receiving this information, the control plane control unit 23 determines the route of each of the communication channels building up the virtual concatenation STS-3C-2v in a way that transmits and receives a control signal on the control plane to and from other transmission devices (S101).

According to the example in FIG. 2 the routes 1 through 4 are selected as the routes between the edge transmission device 11 and the edge transmission device 12. Herein, a cost value of the route 1 is “1”, the cost value of the route 2 is “3”, the cost value of the route 3 is “4”, and the cost value of the route 4 is “5”. The control plane control unit 23 determines the routes capable of accommodating the virtual concatenation STS-3C-2v by giving the priority to the routes in the sequence from the lowest cost value. In the example of FIG. 2, the control plane control unit 23 determines that the route 1 accommodates one channel STS-3C (STS-3C#1), and the route 2 accommodates the remaining channel STS-3C (STS-3C#2).

When this route determination gets successful (S102; YES), the determined route information is exchanged between the respective transmission devices. Each transmission device performs the circuit setup in the cross-connect unit of the self-device on the basis of the route information (S103).

In the edge transmission devices 11 and 12, the control plane control unit 23 notifies the L2 unit 21 of the completion of the circuit setup, whereby the control unit 41 receiving this notification starts the route verifying process. The control unit 41 instructs the monitoring timer 42 to start up the timer (S104), simultaneously instructs the selecting unit 35 to switch over so as to output the POH signal from the POH test signal generator 34, and further instructs the selecting unit 54 to switch over so as to output the signal transmitted from the SONET demapping unit 51 to the POH test signal detector 55. Subsequently, the control unit 41 instructs the POH test signal generator 34 to generate the POH signal for the test signal.

The POH test signal generator 34 generates the POH signal for the test signal on the basis of the instruction given from the control unit 41, and transmits the POH signal to the selecting unit 35. The selecting unit 35 transmits the POH signal for the test signal to the SONET mapping unit 36. The SONET mapping unit 36 maps the POH for the test signal to the POH of each of the signals (STS-3C#1 and STS-3C#2) of the virtual concatenation STS-3C-2v. The thus-generated test signals (DUMMY1#1 and DUMMY1#2) are each transmitted by the cross-connect unit 25 to the should-be-transmitted optical interface unit 22. At this time, the cross-connect unit 25 transmits each test signal to an output destination corresponding to the circuit setup previously done by the control plane control unit 23 (S105).

According to the example in FIG. 3, the DUMMY1#1 signal is transmitted via the route 1 to the opposite edge transmission device 12, while the DUMMY1#2 signal is transmitted via the route 2 (the transmission devices 13 and 14) to the opposite edge transmission device 12.

In the edge transmission device 12, the optical interface unit 22 receives the respective test signals, and these test signals are transmitted through the cross-connect unit 25 to the SONET demapping unit 51 of the L2 unit 21. The SONET demapping unit 51 detaches the POH and the payload out of the signal transmitted from the cross-connect unit 25. The SONET demapping unit 51 sends the detached POH to the POH test signal detector 55 via the selecting unit 54.

The POH test signal detector 55, when receiving each of the POH signals of the virtual concatenation from the selecting unit 54, determines based on each POH signal whether the arrival time difference between the respective test signals via the communication channels falls within the predetermined allowable time (S106). In other words, the POH test signal detector 55 determines whether or not the arrival time difference between the test signal (DUMMY1#1) transmitted via the route 1 and the test signal (DUMMY1#2) transmitted via the route 2 falls within a L2 frame reassembly-enabled time difference range. The POH test signal detector 55, when determining that the arrival time difference between the respective test signals via the communication channels falls within the predetermined allowable time (S106; YES), notifies the control unit 41 of a result of this determination.

Through this process, the POH test signal generator 34 generates each of the POH signals for the test response signals transmitted via the communication channels of the virtual concatenation. The POH signal for the test response signal is transmitted through the selecting unit 35 to the SONET mapping unit 36 and is mapped to POH of each of the signals (STS-3C#1 and STS-3C#2) of the virtual concatenation STS-3C-2v. The thus-generated test response signals (DUMMY2#1 and DUMMY2#2) are each transmitted by the cross-connect unit 25 to the should-be-transmitted optical interface unit 22 (S107).

According to the example in FIG. 3, the DUMMY2#1 signal is transmitted via the route 1 to the opposite edge transmission device 11, while the DUMMY2#2 signal is transmitted via the route 2 (the transmission devices 13 and 14) to the opposite edge transmission device 11.

While on the other hand, the POH test signal detector 55, when determining that the arrival time difference between the respective test signals via the communication channels exceeds the predetermined allowable time (S106; NO), notifies the control unit 41 of a result of this determination. The control unit 41 receives the result of this determination and thereby judges that the now-set-up route is not acceptable, i.e., judges that the present route (extending from the edge transmission device 11 to the edge transmission device 12) disables the L2 frame to be reassembled. Consequently, the control unit 41 instructs the cross-connect unit 25 to cancel the circuit setup (S111). Subsequently, the control unit 41 notifies the control plane control unit 23 of such a purport that the route is not acceptable. With this notification, the control plane control unit 23 executes again a route reconfiguring process (S101).

In the edge transmission device 11, the control unit 41 monitors the timeout. Namely, the control unit 41 monitors the timeout notification sent from the monitoring timer. Herein, if the control unit 41 is notified of the timeout before receiving the determined result notification from the POH test signal detector 55, the then-determined route is judged to be unacceptable, i.e., the present route (extending from the edge transmission device 11 to the edge transmission device 12 or from the edge transmission device 12 to the edge transmission device 11) is judged to disable the L2 frame to be reassembled, then the circuit setup is canceled (S111), and the route reconfiguring process is again executed (S101).

While on the other hand, before the timeout (S108; NO), the POH test signal detector 55 of the edge transmission device 11, when determining that the arrival time difference between the respective test response signals via the communication channels falls within the predetermined allowable time (S109; YES), notifies the control unit 41 of a result of this determination. The control unit 41, which is notified of the result of this determination, judges that the present route setup is acceptable. The control plane control unit 23 is notified of this judgment, and finally the present circuit setup is kept (S110).

When the POH test signal detector 55 determines that the arrival time difference between the respective test response signals via the communication channels exceeds the predetermined allowable time (S109; NO), the control unit 41 is notified of a result of this determination. The control unit 41, which is notified of the result of this determination, judges that the now-set-up route is not acceptable, and instructs the cross-connect unit 25 to cancel the circuit setup (S111). Subsequently, the control unit 41 notifies the control plane control unit 23 of such a purport that the route is not acceptable. With this notification, the control plane control unit 23 again executes the route reconfiguring process (S101).

Note that the control plane control unit 23, on the occasion of executing the route reconfiguring process, when judging that no further routes possibly judged acceptable can be selected (S102; NO), outputs the alarm via the user interface etc (S112).

### Operation and Effect of the Embodiment

According to the embodiment, between the edge transmission devices 11 and 12 that transmit the L2 frame through the virtual concatenation, the edge transmission device 11 transmits the test signals via the plurality of communication channels building up the virtual concatenation, and the edge transmission device 12 receives the test signals via the communication channels. As a result, the transmission device 12 receiving the test signals determines whether or not the arrival time difference between the respective test signals via the communication channels falls within the predetermined allowable time, thereby verifying the route of each of the communication channels building up the virtual concatenation.

This scheme verifies the routes of the plurality of communication channels building up the virtual concatenation, which are automatically set up by the function of the control plane control unit. Namely, even when the respective communication channels are set up on the different routes, it is verified as to whether these set-up routes are the routes enabling the L2 frame to be correctly reassembled in the transmission device serving as the edge of the virtual concatenation.

Hence, according to the embodiment, no matter how the routes of the communication channels may be set up, after verifying that the L2 frame transmitted through the virtual concatenation is correctly assembled, the system can be operated, and therefore the secure system operation can be carried out. The verification is automatically conducted between the transmission devices serving as the edges, and hence a labor needed for the verification can be also omitted.

Moreover, the route verification is determined depending on whether or not the arrival time difference between the respective test signals or the test response signals via the communication channels falls within the predetermined allowable time corresponding to the capacity of the receiving buffers provided in the transmission device.

With this scheme, in the case of receiving the test signals enabling one frame to be assembled at an interval in excess of the size of the receiving buffers, this is determined to be abnormal of the routes, and hence the correct routes can be verified.

Further, when the routes are determined abnormal in the transmission device, i.e., when the routes disabling the L2 frame to be reassembled, which is transmitted through the virtual concatenation, is set up, the routes are reconfigured by the control plane.

Owing to this scheme, according to the embodiment, the labors taken for the route verification and the route configuration can be reduced.

Moreover, in the embodiment, the monitoring timer monitors the timeout in the transmission device that transmits the test signals. This timeout monitor involves monitoring that the test response signal to the test signal is transmitted back from the opposite transmission device within the predetermined monitor time.

This scheme in the embodiment enables the transmission device transmitting the test signals to gasp the result of the route verification either on the onward route or on the return route of each of the communication channels building up the virtual concatenation.

### Modified Example

In the embodiment discussed above, the test signal and the test response signal are transmitted by use of the POH J1 bytes and may also be transmitted by employing the payload.

Further, the embodiment discussed above has exemplified the SONET transmission device, however, an SDH transmission device is also available. In this case, the wording of the terminology or the technical notation may be changed as follows:

STS-1:VC-3

STS-3C:VC-4

What is claimed is:

1. A transmission device transmitting a data frame to an opposite transmission device by use of one virtual transmission path built up by a plurality of communication channels, the transmission device comprising:
a route control unit determining each of routes of the communication channels building up the virtual transmission path between the transmission device and the opposite transmission device;
a circuit setup unit performing a circuit setup of the self-device based on the routes determined by the route control unit; and
a test signal receiving unit receiving test signals transmitted from the opposite transmission device via the communication channels based on the circuit setup by the circuit setup unit; and
a route verifying unit verifying the routes of the communication channels, which are determined by the route control unit, in accordance with an arrival time difference between the respective test signals via the communication channels.

2. A transmission device according to claim 1, further comprising
a test response signal transmitting unit transmitting, if the route verifying unit judges that the routes of the communication channels are normal, the test response signals as responses to the test signals via the communication channels based on the circuit setup by the circuit setup unit.

3. A transmission device according to claim 1, wherein the test signal is transmitted by use of an overhead signal or a payload signal of SONET (Synchronous Optical NETwork) or SDH (Synchronous Digital Hierarchy).

4. A transmission device according to claim 1, wherein the route verifying unit judges, if at least one of the arrival time differences between the respective test signals via the communication channels exceeds a predetermined period of allowable time, that the routes of the communication channels are abnormal, and
the route control unit, if the route verifying unit judges that the routes of the communication channels are abnormal, reconfigures the routes of the communication channels.

5. A transmission device according to claim 1, wherein the route verifying unit judges, if at least one of the arrival time differences between the respective test signals via the communication channels exceeds a predetermined period of allowable time, that the routes of the communication channels are abnormal, and
the route control unit, if the route verifying unit judges that the routes of the communication channels are abnormal, reconfigures the routes of the communication channels.

6. A transmission device according to claim 5, wherein the route control unit, if the reconfiguration of the routes of the communication channels, which might lead to the judgment that the routes of the communication channels are normal, is determined to be impossible, outputs an alarm.

7. A transmission system comprising a first transmission device and a second transmission device that transmit a data frame to each other by use of one virtual transmission path built up by a plurality of communication channels,
each of the first transmission device and the second transmission device, including:
a route control unit determining routes of the communication channels building up the virtual transmission path between the first transmission device and the second transmission device; and
a circuit setup unit performing a circuit setup of the self-device based on the routes determined by the route control unit,
the first transmission device further including:
a test signal transmitting unit transmitting the test signals to the second transmission device via the communication channels based on the circuit setup by the circuit setup unit,
the second transmission device further including:
a test signal receiving unit receiving the test signals transmitted from the first transmission device via the communication channels based on the circuit setup by the circuit setup unit, and
a route verifying unit verifying the routes of the communication channels, which are determined by the route control unit, in accordance with the arrival time difference between the respective test signals via the communication channels.

8. A route verifying method executed by a first transmission device and a second transmission device that transmit a data frame to each other by use of one virtual transmission path built up by a plurality of communication channels, the method comprising the steps of:
determining routes of the communication channels building up the virtual transmission path between the first transmission device and the second transmission device;
conducting a circuit setup of the first transmission device and a circuit setup of the second transmission device based on the determined routes;
transmitting the test signals to the second transmission device from the first transmission device via the communication channels based on the setup circuit;
receiving the test signals transmitted from the first transmission device in the second transmission device via the communication channels based on the setup circuit; and
verifying the determined routes of the communication channels, in accordance with the arrival time difference between the respective test signals via the communication channels.
